(19) United States
(12) Patent Application Publication
(10) Pub. No.: US 2020/0347647 A1
(43) Pub. Date: Nov. 5, 2020

(54) A SECURITY TAG FOR A GARMENT ARTICLE

(71) Applicant: ZLIIDE TECHNOLOGIES APS, Aarhus C (DK)

(72) Inventors: Nikolai Brix Lindholm, Løkken (DK); Casper Schrøder Sørensen, Hjørring (DK); Morten Møgelmose, Bindslev (DK); Viktor Pedersen, Aalborg (DK)

(73) Assignee: ZLIIDE TECHNOLOGIES APS, Aarhus C (DK)

(21) Appl. No.: 16/962,654

(22) PCT Filed: Jan. 17, 2019
(86) PCT No.: PCT/EP2019/051165

§ 371 Date: Jul. 16, 2020

(30) Foreign Application Priority Data
Jan. 18, 2018 (EP) 18152382.0

(51) Int. Cl. E05B 73/00; G08B 13/24; E05B 15/04

(52) U.S. Cl. CPC E05B 73/0017; E05B 47/0004; E05B 15/04; G08B 13/2434

(57) ABSTRACT

A security tag for a garment article for anti-theft purpose. The security tag has a first tag part, and a second tag part for sandwiching the garment article between the first tag part and the second tag part. The first tag part comprises three locks including a pin lock for locking a pin of the second tag part to the first tag, and an electronic lock, which in turns locks the pin lock. The pin lock may be formed as a spring clip.

The present invention relates to a security tag for a garment article for anti-theft purpose, i.e. for preventing or discouraging theft of the garment article from a retail shop.

Specifically, the security tag is suitable for a self-checkout system where customers may process their own purchases from the retailer shop without going to a physical point of sale, i.e. a traditional cashier-staffed checkout point with a cash register.

In this way, the customer may save time, and avoid standing in line at the checkout point. In addition, such a system may free up time from the staff, and the staff may spend the time servicing the customers instead.

The present invention further relates to a self-checkout system for purchasing a garment article, and unlocking a security tag attached to the garment article.

A security system in retail shops typically consist of an electronic article surveillance system comprising a transmitter/receiver setup, where the transmitter is secured to the garment article means of a security tag, and the receiver is located at an exit of the retail shop. As the transmitter passes the receiver, the receiver picks up a signal from the transmitter, and sounds an alarm.

The security system may also be GPS based with the security tag comprising a GPS unit.

Furthermore, the security tag may comprise an alarm and/or an ink chamber with ink, which may be released if the security tag is manipulated.

Examples of security tags are disclosed in US2016364969, and US2017306657, which are incorporated in the present disclosure by reference.

It is an object of the present invention to provide a security tag, which may be controlled electronically, and unlocked without an excessive power consumption, and without doing damage to the garment article.

The above object and advantages together with numerous other objects and advantages, which will be evident from the description of the present invention, are according to a first aspect of the present invention obtained by:

A security tag for a garment article for anti-theft purpose, said security tag comprising: a first tag part, and a second tag part for sandwiching said garment article between said first tag part and said second tag part,

said first tag part comprising:
a pin lock for receiving a pin and securing said pin,
a handle for locking and unlocking said pin lock, said handle being movable between a first position and a second position, said pin being secured by said pin lock when said pin lock being locked by said handle in said first position,
   said pin being releasable from said pin lock when said pin lock being unlocked by said handle in said second position,
   said first tag part further comprising:
a handle lock for arresting said handle in said first position,
   said second tag part comprising:
   a pin head with said pin extending from said pin head for penetrating said garment article, and engaging said pin lock for locking said first tag and said second tag together.

Anti theft purpose is to be understood as meaning preventing or discouraging theft of the garment article. The garment article may be a woven or non woven piece of textile cloth such as a curtain, tablecloth, clothes in the form of a pair of jeans, or shoes, a jacket, etc.

The pin is relatively thin in order not to leave a relatively large hole in the garment article (diameter of less than 0.5 cm). Due to the weight of the security tag and the relatively thin pin, the pressure on the garment article by the pin may damage the garment article.

Damage to especially thin pieces of garment is reduced by sandwiching the garment between parts of the security tag—either between a first tag part and a second tag part or between a first tag part and a third tag part. Each tag part on opposite sides of the garment article having a surface contacting the garment article such that the weight of the security tag is not carried by the pin, but by the surfaces contacting the garment article.

The term sandwiching is to be understood as having something in-between two other things, i.e. a layered structure with a central layer having layers on opposite sides of the central layer. The layers are not limited to only include two tag parts, i.e. the garment article may be sandwiched between the first tag part and the third tag part, and the garment article and the third tag part may be sandwiched between the first tag part and the second tag part (the cross section of which being a four layered structure).

It is contemplated that the handle functions as a manual lock, i.e. it is locked and unlocked by a manual force applied by the user (by moving or sliding the handle). This reduces the power consumption of the security tag, and the pin lock may be locked with a greater force than for example what a battery could provide. The handle may be in the form of button such as a push button, which may be moved by depressing or pushing by the user.

The term locking should be understood in the sense that a key is required to do the unlocking if there should be no risk of damaging the garment article, such as tearing a hole in the garment article if trying to unlock the security tag by brute force—for example by trying to force the tag parts away from each other.

The pin is locked by the pin lock, and the pin lock is locked by the handle, which is key for unlocking the pin lock. Similarly, the handle is locked by the handle lock, and the key for the handle lock is a signal from a control unit such as a mobile phone.

When unlocking the handle lock, the handle is free to be moved by the user such that the user can unlock the pin lock.

In general, the terms arresting, securing and locking are to be understood as limiting the freedom of movement of a movable object (stopping the object), i.e. the pin is secured or locked in a fixed position by the pin lock so that only by an excessive amount of force, the pin may be removed from an otherwise locked security tag—excessive meaning much higher than what is needed if the lock of was unlocked with a key.

Similarly, the handle is locked in a fixed position by the handle lock, i.e. the handle lock arrests or stops a movement of the handle in an unlocking direction of the handle unless the handle lock is unlocked.

According to a second aspect of the present invention the above objects and advantages are obtained by:

A system for self-checkout and purchasing a garment article, said system comprising

said garment article being secured with the security tag according to the first aspect,
said security tag being in a locked state,
said system further comprising a control unit for unlocking said security tag.

According to a third aspect of the present invention the above objects and advantages are obtained by:

A security clip for locking a pin, said pin having a pin head and a pointy end opposite said pin head, said security clip comprising:
a bottom with a bottom surface and a bottom aperture for receiving said pointy end of said pin,
a clip axis through said bottom aperture,
a first spring arm extending from said bottom, and defining a first spring, and having an inclination with respect to said bottom surface,
   said first spring arm comprising:
   a first end constituting a free end, and a second end opposite said free end, said first spring arm connected to said bottom at said second end at a distance from said bottom aperture,
   a first spring aperture for receiving said pointy end of said pin such that said pin extending through said bottom aperture and said first spring aperture when said pin being in said security clip,
   said first spring aperture defined in part by a contact edge for contacting said pin when said pin being in said security clip,
   the projection of said contact edge onto said bottom surface being between said clip axis and said second end in the equilibrium state of said first spring, and
   the projection of said contact edge onto said bottom surface being on the opposite side of said clip axis than said second end in a compressed state of said first spring such that said contact edge being forced towards said clip axis for exerting a locking force on said pin when said pin being in said security clip.

The projection is to be understood as a parallel projection, i.e. it is a perspective projection with an infinite focal length.

Thus, in a relaxed state (equilibrium state), the contact edge or contact point is on one side of the clip axis.

When the spring is compressed by folding it (such that the free end comes closer to the bottom compared to the relaxed state), the contact edge is on an opposite side of the clip axis.

Additionally, the security clip may comprise a second spring arm defining a second spring. The second spring arm extends away from the bottom in a direction with a component that is parallel to the clip axis—like the first spring arm extends away from the bottom in a direction with a component that is parallel to the clip axis. The directions of the two spring arms respectively are mirror images of each other in a plane between the spring arms and parallel with the clip axis.

The second spring arm may have a second free end, and be connected to the bottom at a connection end opposite the free end at a distance from the bottom aperture.

It may also have a second spring aperture for receiving the first spring arm—as well as the pointy end of the pin. Thus, the second spring arm may merge or overlap with the first spring arm.

The second spring aperture may be defined in part by a second contact edge for contacting the pin when the pin being in said security clip.

The projection of the second contact edge onto the bottom surface being between the clip axis and the connected end in the equilibrium state of the second spring.

The projection of the second contact edge onto the bottom surface being on the opposite side of the clip axis than the connected end in a compressed state of the second, i.e. between the clip axis and the second end.

Thus, the second contact edge being forced towards the clip axis for exerting a locking force on the pin when the pin being in said security clip, i.e. the first spring arm and the second spring arm provide opposing locking forces—opposing meaning that the two locking forces each have a component in a direction towards each other. The two locking forces also each have a component in a direction parallel with the clip axis—in a direction away from the bottom aperture.

The term pointy end refers to the pin being suitable for going through a garment article or that it at least have a smaller diameter at one end than at another (opposite) end, i.e. the pin head have a larger diameter than the pointy end.

According to a fourth aspect of the present invention the above objects and advantages are obtained by:

A security tag for a garment article for anti-theft purpose, said security tag comprising: a first tag part, and a second tag part for sandwiching said garment article between said first tag part and said second tag part,

said first tag part comprising:
a pin lock for receiving a pin and securing said pin, said pin being secured by said pin lock when said pin lock being locked
   said pin lock comprising a spring, said spring being in a first deflected state different from the equilibrium state when said pin lock being locked,
   said first tag part further comprising:
   a security lock for locking and unlocking said pin lock,
   said security lock having an actuator being movable between a first position and a second position,
   said pin lock being locked when said actuator being in said first position, and said pin being releasable from said pin lock when said actuator being in said second position,
   said spring being deflected from said first deflected state to a second deflected state when said actuator moving from said first position to said second position,
   said second tag part comprising:
   a pin head with said pin extending from said pin head for penetrating said garment article, and engaging said pin lock for locking said first tag and said second tag together.

The deflection/compression of the spring when the actuator is in the second position is greater than the deflection/compression when the actuator is in the first position. Thus, the actuator performs a work on the spring when going from the first deflected state to the second deflected state, i.e. the actuator works against the direction of the spring force—in the second deflected state, the spring is further away from the equilibrium state than in the first deflected state, i.e. more energy is stored in the spring in the secand deflected state.

The security lock may be a handle/button or an electric motor having a plunger or rod for contacting the spring possibly via a wedge in a case where the actuator moves in a direction orthogonal to the direction of the spring.

The invention will now be explained in more detail below by means of examples of embodiments with reference to the very schematic drawing, in which

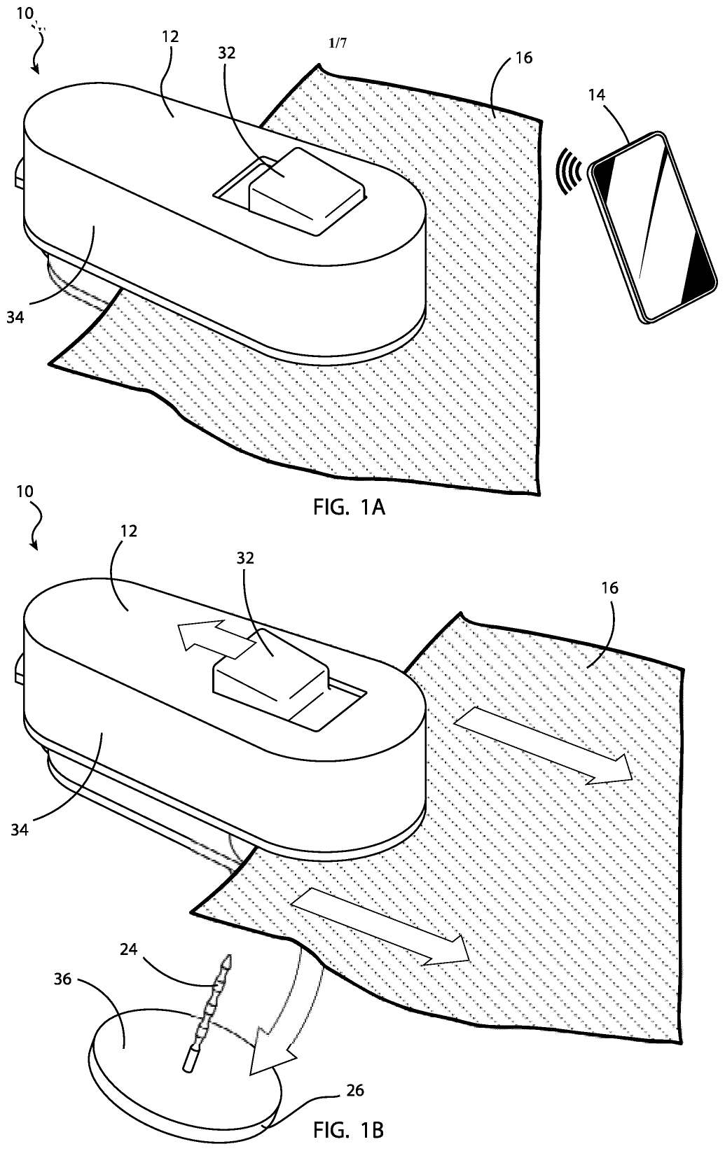

FIG. 1A shows a system with a security tag, a garment article and a control unit.

FIG. 1B shows a security tag, and a garment article.

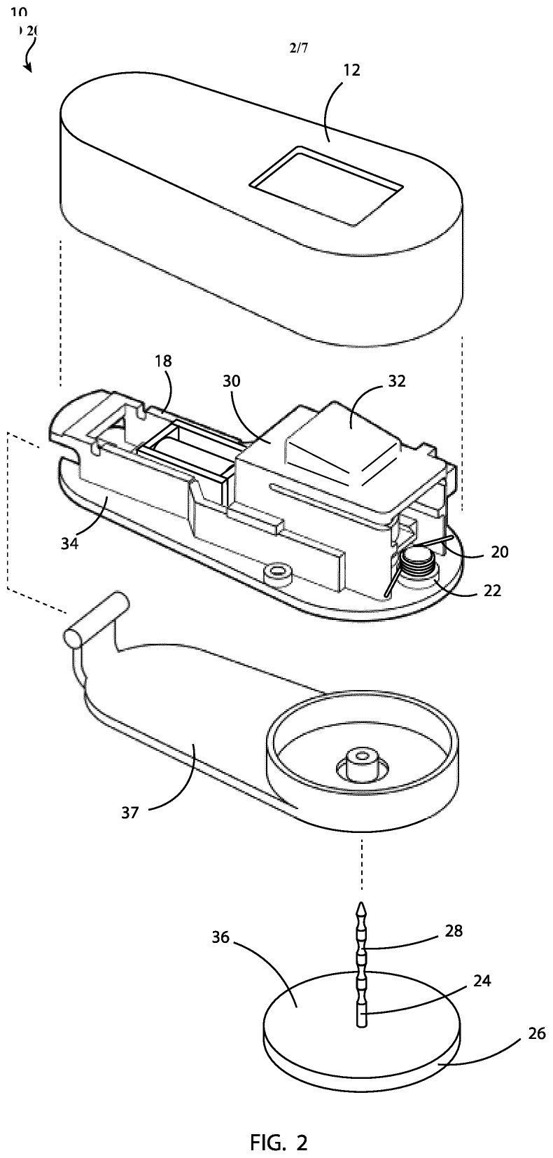

FIG. 2 shows an exploded view of a security tag.

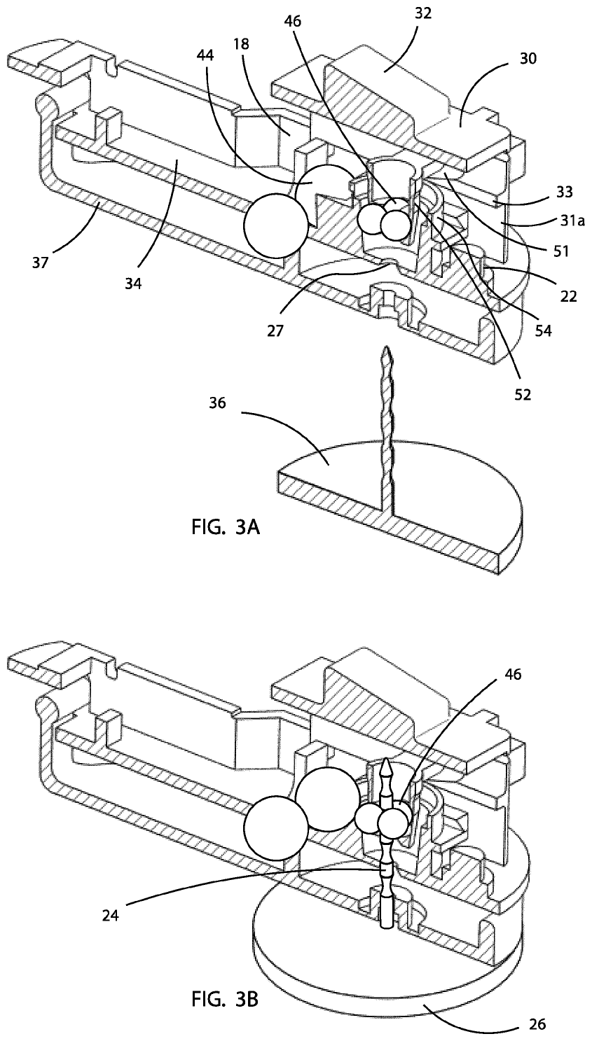

FIG. 3A shows a perspective of a security tag being cut in half.

FIG. 3B shows a perspective of a security tag being cut in half.

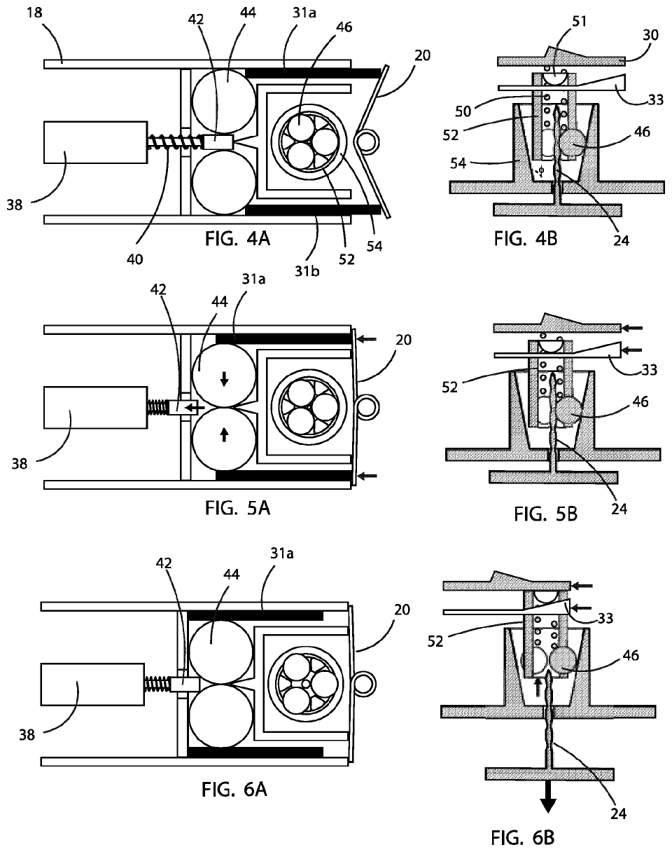

FIG. 4A shows a top perspective of a cutaway view of a security tag in a locked state.

FIG. 4B shows a side perspective of a cross section of the security tag in FIG. 4A.

FIG. 5A shows a top perspective of a cutaway view of a security tag in a semi locked state.

FIG. 5B shows a side perspective of a cross section of the security tag in FIG. 5A.

FIG. 6A shows a top perspective of a cutaway view of a security tag in a unlocked state.

FIG. 6B shows a side perspective of a cross section of the security tag in FIG. 6A.

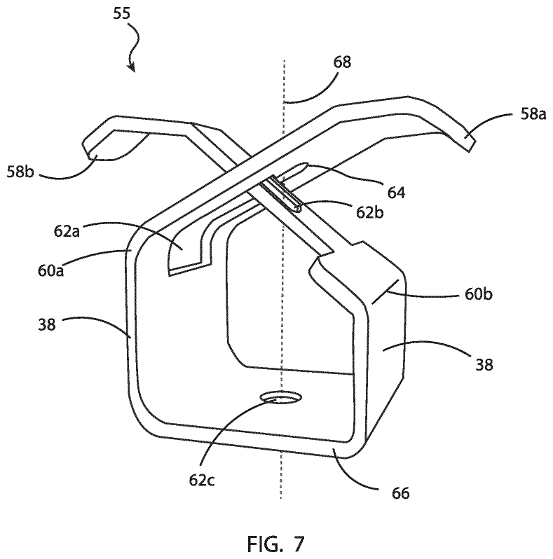

FIG. 7 shows a perspective of an alternative pin lock.

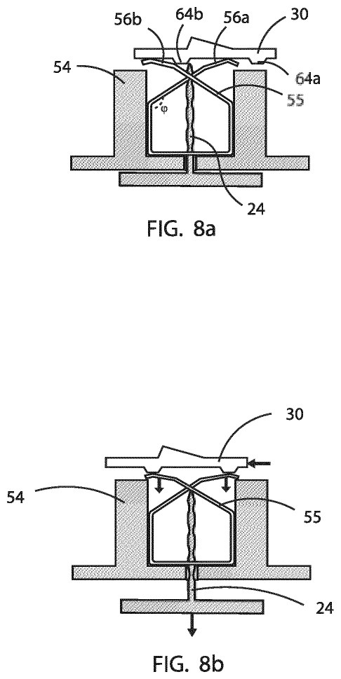

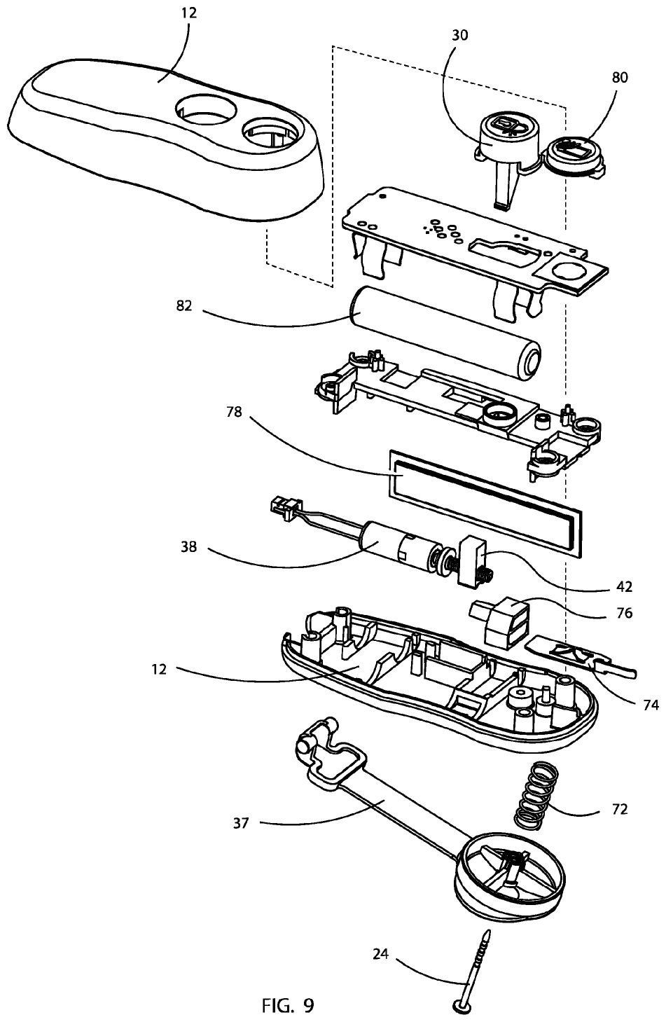

FIG. 8a shows a perspective of a cross section of a pin lock in a locked state.

FIG. 8b shows a perspective of a cross section of a pin lock in an unlocked state.

FIG. 2 shows an exploded view of a security tag.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will, thus, not be described in detail with respect to the description of each figure.

FIG. 1A shows a system with a security tag, a garment article and a control unit.

The security tag 10 is locked to a garment article 16, which is supplied for sale in a retail shop for example. The garment article is a piece of textile either woven or non woven. The security tag is controlled by a control unit 14 and a user (not shown).

The security tag of consists of a first tag part 34, and a second tag part 36, which can be seen in FIG. 1B. The second tag part has a pin 24 with a pointy end, which goes through the garment article so that the garment article is sandwiched between the first tag part and the second tag part.

The locking is explained in detail in FIGS. 4-6. The pin is locked to the first tag part by a pin lock of the first tag part. The pin lock is mechanical, and exerts a force on the pin by means of a compression spring 50 being in a compressed state.

The pin lock is locked and unlocked mechanically by means of a handle 30 with a handle protrusion 32.

The handle is movable between a first position and a second position. In the first position, the handle locks the pin lock, which in turn locks the pin. In the second position, the pin lock is unlocked. The handle protrusion may be used to move the handle between the first position, and the second position.

It is contemplated that the control unit and security tag may communicate wirelessly via Bluetooth protocol, i.e. the security tag, and control unit both comprise a Bluetooth chip where the control unit is master and the security tag is slave. Other wireless communication protocols may be used such as NFC or WIFI.

The control unit is a mobile device (handheld computer) with software (app) for performing the transaction, where the user (customer) purchases the garment article by paying the retail shop the price of the garment article using the app for executing the purchase.

The app is a transaction app supplemented with payment abilities for executing a financial transaction. Alternatively, a separate payment app such as Mobile Pay or PayPal may be provided on the control unit, which communicates with the transaction app during the transaction.

The security tag has a security tag switch (not shown) for turning on the security tag Bluetooth chip, and initiating a pairing procedure between the security tag and the control unit.

The security tag has a cover 12 forming part of a security tag housing covering internal electric and mechanical systems such as battery and printed circuit board. The security tag also has an electronic lock (handle lock) for locking the security tag to the garment article. Specifically, the handle lock locks the handle in the first position.

The electronic lock is electrically connected to a security tag chip on a printed circuit board inside the security tag housing. The security tag chip is also electrically connected to the security tag Bluetooth chip.

The transaction is initiated by the user opening the transaction app. The transaction app may turn on the control unit Bluetooth chip if the control unit Bluetooth chip is not already active. Alternative, the transaction app may prompt the user to activate the control unit Bluetooth chip to initiate pairing of the security tag and the control unit.

As the control unit Bluetooth chip is active and the transaction app is open, the user switches on the security Bluetooth chip by means of the security tag switch for completing the pairing of the security tag and the control unit.

After the pairing of the security tag and the control unit, information about the garment article is loaded into the transaction app (for example price information).

The price information may be loaded into the payment app together with ID of the retail store such that an amount corresponding to the price of the garment article may be transferred from the user to the retail store in a payment transaction.

After the payment transaction has been performed, the security tag is unlocked, and the security tag may be removed from the garment article. The security tag is unlocked by the control unit communicating a signal to the security tag, i.e. the signal is received by security tag Bluetooth chip, communicated to the security tag chip, which electrically controls the electronic lock such that it unlocks.

FIG. 1B shows a security tag, and a garment article.

In FIG. 1B, the security tag has been unlocked. Specifically, the transaction described in connection with FIG. 1A has taken place, and the handle lock has been unlocked such that the security tag can be removed from the garment article. Specifically, the handle is moved to the second position thereby unlocking the pin lock so that the pin can be removed from the first tag part.

FIG. 2 shows an exploded view of a security tag.

Starting from top, FIG. 2 shows the cover 12 with an opening for the handle projection 32 of the handle 30.

The first tag part 34, has a frame 18 for guiding the handle between the first position and the second position. A torsion spring 20 exerts a force on the handle towards the second position. The torsion spring is mounted to the first tag part by means of a torsion spring holder 22.

The security tag of FIG. 2 has an optional third tag part 37, which is pivotally mounted to the first tag part.

Ending at the bottom, FIG. 2 shows the second tag part 36 having a pin 24, a pin head 26. The pin has a serration 28 for cooperating with the pin lock.

FIG. 3A shows a perspective of a security tag being cut in half.

The cut off view of FIG. 3A illustrates the internal construction of the security tag, and in the following, the pin lock will be described in greater detail.

The pin lock is a ball lock mechanism.

The pin lock comprises a first locking ball 46, and two other locking balls, which are in a ball housing 52, which again is in a lock housing 54.

It is contemplated that instead of three locking balls, two or four locking balls or any number from two and up may be used.

The ball housing is a cylindrical structure. It has a bottom with a bottom surface facing the locking balls. The bottom surface supports the locking balls. A ball housing sidewall extends from the bottom.

The ball housing sidewall has an opening for each locking ball such that each locking ball may move radially inside said ball housing. Each hole has a size smaller than the diameter of a locking ball.

Opposite the bottom surface is a compression spring 50 (which is explained in greater detail in FIGS. 4-6) so that the locking balls are between the bottom surface and the spring.

The lock housing 54 has a lock sidewall with a lock surface facing the ball housing. In the bottom of the lock housing is a first aperture 27 in which the pin 24 goes through when it is inserted in the pin lock. The ball housing has a second aperture in which the pin goes through after it has gone through the first aperture.

The lock surface is inclined, i.e. the lock surface has an angle ϕ with respect to the bottom of the lock housing which is greater than 90° such as 110°. Thus, the internal diameter of the lock housing decreases towards the bottom of the lock housing.

As mentioned above, the pin lock includes a compression spring, which in the locked state of the pin lock forces the locking balls and the ball housing towards the bottom of the lock housing.

The compression spring is compressed by the handle 30 in that the distance between the locking balls and a bottom surface of the handle is less than the equilibrium length of the compression spring.

The handle has first handle sidewall 31a and a second handle sidewall (not shown) opposite the first handle sidewall. The handle sidewalls are guided by the frame of the first tap part such that the handle may be slided back and forth between the first position and the second position, i.e. the frame forms a track for the handle sidewalls.

The first handle sidewall has a first handle flange 33, which cooperates with a lock wing 51 extending from the ball housing sidewall, i.e. the first handle flange has a flange ramp for lifting the lock wing and thereby the ball housing.

Thus, the pin lock is locked and unlocked by means of the handle, i.e. when the handle is moved away from the torsion spring, the lock wing slides onto the flange ramp, which causes the ball housing to move away from the bottom of the lock housing, which leaves a greater radius for the locking ball so that they can move away from the pin.

The handle has to be moved with a force greater than the force of the compression spring.

FIG. 3B shows a perspective of a security tag being cut in half.

Compared to FIG. 3A, the first tag part, and the second tag part have been locked together.

The three locking balls of the pin lock surrounds the pin 24. As the ball housing is moved towards the bottom of the lock housing, the locking balls comes into contact with the lock sidewall and is forced radially towards the pin into contact with the pin.

The pin serration means that the pin has a decreased diameter, and the locking balls may go into the serration thereby arresting the pin and preventing the pin from being pulled out of the pin lock.

FIG. 4A shows a top perspective of a cutaway view of a security tag in a locked state.

In FIG. 4A, the handle is in the first position so that the security tag is locked, and in the following, the handle lock is described in greater detail.

The handle lock is an electronic locking mechanism in the form of a solenoid lock.

The handle lock comprises a first plunger ball 44, and a second plunger ball. The plunger balls limit the movement of the handle sidewalls 31a, 31b, i.e. when the first plunger ball contacts the frame/track 18, the first handle sidewall is prevented from being pulled back, because it comes into contact with the first plunger ball, which stops movement of the handle.

The plunger balls cannot be moved out of the way of the handle sidewalls, because of a plunger 42, which forces the plunger balls away from each other towards and into the track where the handle sidewalls move.

The plunger is magnetic, and it is connected to a latching type linear electromechanical actuator in the form of a linear solenoid 38, i.e. it can be turned on and off.

When the solenoid is off, a return spring 40 forces the plunger away from the solenoid such that the plunger balls prevents movement of the handle, i.e. the return spring is in a compressed state (the distance between the solenoid and the plunger balls is smaller than the equilibrium length of the return spring.

When the solenoid is on, the magnetic field generated by the solenoid coils forces the plunger towards the solenoid. The force exerted by the magnetic field on the plunger is greater than the force exerted by the return spring. Thus, the return spring is further compressed.

The torsion spring 20 makes sure that the handle does not by itself move to the locked position (first position), i.e. the torsion spring exerts a force on the handle in a direction towards the solenoid, but the force of the torsion spring is less than the force of the return spring when the handle lock is locked (the solenoid is off). Thus, the handle has to be moved to the first position manually.

FIG. 4B shows a side perspective of a cross section of the security tag in FIG. 4A.

The compression spring 50 forces the locking balls, and ball housing 52 towards the bottom of the locking housing 54 so that the locking balls are forced radially towards the pin 24 by the lock sidewall of the locking housing in order to arrest the pin 24.

FIG. 5A shows a top perspective of a cutaway view of a security tag in a semi locked state.

In FIG. 5A, the solenoid is on, which means that the plunger is pulled into the solenoid, and the plunger balls has moved away from the path of the sidewalls of the handle.

FIG. 5B shows a side perspective of a cross section of the security tag in FIG. 5A.

The cross section of FIG. 5B includes part of the lock wing 51, part of the first handle flange 33, and part of a second locking ball. All of which are in a different plane than the parts with hatched areas.

As can be seen in FIG. 5B, the handle is not yet moved so far back that the lock wing 51 has moved onto the flange ramp of the first handle flange.

FIG. 6A shows a top perspective of a cutaway view of a security tag in a unlocked state.

The handle has been moved to the second position (unlocked position) so that the security tag is unlocked, which is illustrated in FIG. 6A by the locking balls are further apart from each other than in FIGS. 4A and 5A. Thus, the locking balls are no longer engaging the pin, which means that the pin can be moved out of the pin lock.

FIG. 6B shows a side perspective of a cross section of the security tag in FIG. 6A.

As can be seen in FIG. 6B, the handle has been moved so far back that the lock wing 51 has moved onto the flange ramp of the first handle flange, which means that the ball housing 52 has been moved away from the bottom of the lock housing to a position with greater diameter of the lock housing so that the locking balls have space to disengage the pin 24.

In the unlocked state, the compression spring is further compressed than in FIGS. 4B and 5B.

FIG. 7 shows a perspective of an alternative pin lock.

The pin lock of FIG. 7 is a spring clip 55 (security clip), which directly engages the pin serration without the use of locking balls.

The spring clip is constituted by a metal plate, which has been folded at a number of folds into a U-shape having a spring bottom 66, and two spring arms 56a, 56b respectively—each spring arm extending from the spring bottom towards a free end 58a, 58b respectively, and the spring arms are across from each other.

Each spring arm has a fold 60a, 60b respectively, where the two spring arms are folded towards each other. Thus, each spring arm has a lower arm part (between the fold and the spring bottom), and an upper arm part (between the fold and the free end).

Each spring arm constitutes an elastic object that stores mechanical energy, i.e. when a spring arm is bend away from its resting position (equilibrium state), it exerts an opposing force.

The first spring arm 56a has a first spring aperture 62a for accommodating the second spring arm 56b.

The second spring arm 56b has narrow part with a width, which is smaller after the second fold 60b than before the second fold—as seen from the spring bottom.

Thus, the second spring arm has a width, which is smaller than the width of the first spring aperture so that the second spring arm fits within the first spring aperture.

The second free end 58b is on an opposite side of the first spring sidewall than the second sidewall fold 60b.

The second spring arm has a second spring aperture 62b for accommodating a pin. The second spring aperture being in the narrow part of the second spring sidewall.

The spring bottom has a bottom aperture 62c also for accommodating the pin such that a clip axis 68 orthogonal to the spring bottom extends through the bottom aperture, the first spring aperture and the second spring aperture.

The first spring arm has a first contact area 64 for contacting a first side of the pin, i.e. the first spring arm has a first edge defining the first spring aperture 62a, and the first contact area 64 is constituted by the part of the first edge, which is towards the first free end 58a.

The second spring arm has a second contact area (not shown) for contacting a second side of the pin opposite the first side, i.e. the second spring sidewall has a second edge defining the second spring aperture 62b, and the second contact area is constituted by the part of the second edge, which is towards the second free end 58b.

FIG. 8a shows a perspective of a cross section of a pin lock in a locked state.

The pin lock shown in FIG. 7 is in the lock housing 54, and the pin 24 extends through the bottom aperture, the first spring aperture, and the second spring aperture.

Both the first spring arm 56a, and the second spring arm 56b are in a compressed state with the first fold having an obtuse angle φ greater than 100° and less than 160°, and the second fold also having an obtuse angle greater than 100° and less than 160°. The angle being greater in the equilibrium state than in the compressed state.

The pin arrests the two spring arm in the compressed state, which in turn keeps the pin in the locked position.

Thus, the first spring arm provides a spring force having a component in a direction towards the pointy end of the pin, and a component in a direction towards the pin. Similarly, the second spring arm provides a spring force having a component in a direction towards the pointy end of the pin, and a component in a direction towards the pin.

The first contact area of the first spring therefore contacts the pin on a first side of the pin, and the second contact area contacts the pin on a second side of the pin opposite the first side.

The handle has a first handle camber 64a, and a second handle camber 64b for further compressing the plate spring 55.

The heights of the handle cambers are so that in the locked state, the spring sidewalls contact the pin before contacting the handle.

FIG. 8b shows a perspective of a cross section of a pin lock in an unlocked state.

In FIG. 8b, the handle lock has been unlocked so that the handle is moved from the first position to the second position.

In the second position, the first handle camber is in contact with the first spring arm, and the second handle camber is in contact with the second spring arm. Thus, the first handle camber further compresses the first spring arm, and the second handle camber further compresses the second spring arm.

When the first spring arm is further compressed compared to the locked state, the first contact area is away from the pin.

Similarly, when the second spring arm is further compressed compared to the locked state, the second contact area is also away from the pin, which means that the pin is free to move out of the pin lock.

FIG. 9 shows an exploded view of a security tag.

The security tag shown in FIG. 9 comprises in substance the same parts as the security tag shown in the previous figures, but with a slightly different re-arrangement of the parts, and the mechanical function or interaction between the movable parts.

Specifically, FIG. 9 illustrates an exploded view of the internal construction of the security tag.

The security tag has a first tag part, a second tag part comprising a pin 24, and a third tag part 37.

The components of the first tag part are the components illustrated from the top starting with a cover 12 and down to a frame 18.

The security tag locks a garment by sandwiching the garment between the first tag part and the second tag part. The third tag part is optional and may be used to decrease the pressure on the garment, i.e. so that the garment and the third tag part are sandwiched between the first tag part and the second tag part.

The second tag part also comprises a pin head, and there may be serrations on the pin.

The pin is to extend through the third tag part and going up into the first tag part via a hole in the frame 18.

The pin engages a pin lock constituted by a tension spring 74. The tension spring has a spring opening, which the pin goes into.

The tension spring is pivotable mounted to the frame such that it is movable/rotatable with respect to the pivot point in a plane orthogonal to the pin when the pin is placed in the pin lock. The tension spring has a distal end compared to the pivot point.

Three states of the tension spring may be defined with corresponding positions of the tension spring. An equilibrium state, a locked state, and an unlocked state.

The tension spring is placed having the equilibrium state such that the tension spring is displaced/deflected from the position in the equilibrium state when the pin is locked in the pin lock, i.e. locked by the tension spring.

The opposing force due to the tension spring being deflected from its equilibrium state, forces the tension spring towards the position in the equilibrium state, but will be prevented from reaching the position in the equilibrium state due to the pin blocking the path which the tension spring needs to travel—the tension spring exerts a force on the pin in a direction orthogonal to the pin.

Specifically, a part of the edge defining the spring opening (contact part) engages the pin. Hereby friction will arise if it is attempted to pull the pin out of the pin lock. It will be of even greater difficulty to remove the pin if the pin is serrated.

The spring opening spans an angle in which the tension spring may move without contacting a part of the edge defining the spring opening. This is useful in order to remove the pin from the pin lock.

The pin lock may be unlocked by displacing the tension spring away from its position in the locked state, i.e. displaced further away from the equilibrium state such that the contact part of the edge defining the spring opening does not engage the pin. Hereby the tension spring is in a position such that the pin may be removed from the pin lock, i.e. the tension spring is in an unlocked state.

A handle 30 may be used to unlock the pin lock, i.e. the handle may be used to force the tension spring away from its position in the locked state to its position defining the unlocked state.

The user handling the handle has to exert a force to the handle for overcoming the spring force of the tension spring in order to unlock the pin lock. This is similar to the situation illustrated in FIGS. 4 to 6 where the compression spring 50 in the pin lock of the other security tag described above is further compressed by exerting a force to the handle 30 such that the compression spring is further compressed such that the pin may be removed.

In FIG. 9 the handle constitutes a button which is pressed down for unlocking the pin lock. The button moves in a direction orthogonal to the movement of the tension spring. Thus, the motion of the button is translated by means of a wedge shape side of the button with an inclination congruent to a wedge shaped side of a slider 76.

The slider is connected to the distal end of the tension spring such that the tension spring moves with the slider.

The spring force of the tension spring causes the button to be in its elevated position.

The frame has a track in which the slider may slide back and forth.

For security reasons or anti-theft purposes, the security tag has a handle lock for locking or arresting the handle or slider such that the pin lock is prevented from being unlocked.

The handle lock may be electronically controlled for example via a wireless signal received by an antenna 78. The antenna is part of an electric circuit for controlling the handle lock. The electric circuit is supported on a printed circuit board, and powered by a battery 82. The electric circuit may be activated or powered on by an activation switch 80 next to the handle button 30.

The handle lock comprises a plunger 42, which is driven by a electric motor/actuator having a solenoid 38. The plunger may move linearly between a position where the handle lock is locking the handle or preventing the handle from moving, and a position where the handle may move such that the pin lock may be unlocked.

In the locked position of the handle lock, the plunger engages the slider, i.e. goes into the path of the slider so that the tension spring cannot be moved into its unlocked state.

As an alternative, the electric motor or actuator may comprise a wire made of a shape memory alloy such as Nitinol, and an electric heater such as a resistor for heating the wire.

At room temperature, the wire is positioned and shaped such that part of the handle lock (the plunger for example) is in the path of the movement of a part of the handle such that the handle is arrested. The wire may for example be shaped as a coil/helix, and the plunger may be connected to the wire.

An electric heater such as a resistor may be placed in proximity to the wire such that heat from the electric heater may heat the wire such that the wire changes shape. The shape at a temperature above room temperature causing the plunger to move out of the path of the handle whereby the pin lock may be unlocked.

The third tag part 37 comprises a coil spring 72 for moving the third tag part away from the first tag part when the security tag is unlocked.

In the following is given a list of reference signs that are used in the detailed description of the invention and the drawings referred to in the detailed description of the invention.

| | |
|---|---|
| 10 | Security tag |
| 12 | Cover |
| 14 | Control unit |
| 16 | Garment article |
| 18 | Frame |
| 20 | Torsion spring |
| 22 | Torsion spring holder |
| 24 | Pin |
| 26 | Pin head |
| 27 | First aperture |
| 28 | Pin serration |
| 30 | Handle |
| 31a | First handle sidewall |
| 31b | Second handle sidewall |
| 32 | Handle protrusion |
| 33 | First handle flange |
| 34 | First tag part |
| 36 | Second tag part |
| 37 | Third tag part |
| 38 | Solenoid |
| 40 | Return spring |
| 42 | Plunger |
| 44 | First plunger ball |
| 46 | First locking ball |
| 50 | Compression spring |
| 51 | Lock wing |
| 52 | Ball housing |
| 54 | Lock housing |
| 55 | Plate spring |
| 56a | First spring sidewall |
| 56b | Second spring sidewall |
| 58a | First free end |
| 58b | Second free end |
| 60a | First sidewall fold |
| 60b | Second sidewall fold |
| 62a | First spring aperture |
| 62b | Second spring aperture |
| 62c | Bottom aperture |
| 64 | First contact area |
| 66 | Spring bottom |
| 68 | Clip axis |
| 70a | First handle camber |
| 70b | Second handle camber |
| 72 | Coil spring |
| 74 | Tension spring |
| 76 | Slider |
| 78 | Antenna |
| 80 | Activation switch |
| 82 | Battery |

1-17. (canceled)

18. An anti-theft security tag for a garment article, comprising:
a first tag part, comprising:
a pin lock configured for receiving and securing a pin;
a handle configured for locking and unlocking said pin lock, said handle being movable between a first position and a second position;
wherein said pin is secured by said pin lock when said pin lock is locked by said handle being in said first position;
wherein said pin is releasable from said pin lock when said pin lock is unlocked by said handle being in said second position;
wherein said first tag part further comprises a handle lock configured for arresting said handle in said first position; and
a second tag part comprising:
a pin head from which said pin extends so as to be positioned to penetrate said garment article and for engaging said pin lock to lock said first tag part and said second tag part together when said garment article is sandwiched therebetween.

19. The anti-theft security tag according to claim 18, wherein said handle lock comprises:
a wire made of a shape-memory alloy; and
an electric heater operable for heating said wire;
wherein said wire has a first shape defining a first state at room temperature and a second shape defining a second state at a temperature above room temperature, wherein said handle is arrested when said wire is in said first state, and wherein said handle is unlocked when said wire is in said second state.

20. The anti-theft security tag according to claim 18, further comprising a third tag part configured for sandwiching said garment article between said first tag part and said third tag part, and for sandwiching said third tag part between said garment article and said second tag part.

21. The anti-theft security tag according to claim 20, wherein said third tag part is pivotably connected to said first tag part.

22. The anti-theft security tag according to claim 18, wherein said pin head defines a first plane, and wherein said pin extends in a direction orthogonal to said first plane.

23. The anti-theft security tag according to claim 18, wherein said first tag part comprises a bottom with a bottom surface configured for abutting said garment article.

24. The anti-theft security tag according to claim 18, wherein said pin lock comprises a locking spring configured for providing a locking force against said pin.

25. The anti-theft security tag according to claim 18, wherein said pin lock comprises a locking ball configured for arresting said pin.

26. The anti-theft security tag according to claim 18, wherein said handle lock comprises a plunger ball configured for arresting said handle.

27. The anti-theft security tag according to claim 26, wherein said handle lock comprises a plunger configured for arresting said plunger ball.

28. The anti-theft security tag according to claim 27, wherein said handle lock comprises an actuator configured for displacing said plunger.

29. A system for self-checkout and purchasing a garment article, said system comprising
a security tag comprising a first security tag part and a second security tag part;
wherein said first security tag part comprises:
a pin lock configured for receiving and securing a pin;
a handle configured for locking and unlocking said pin lock, said handle being movable between a first position and a second position;
wherein said pin is secured by said pin lock when said pin lock is locked by said handle being in said first position;
wherein said pin is releasable from said pin lock when said pin lock is unlocked by said handle being in said second position;
wherein said first security tag part further comprises a handle lock configured for arresting said handle in said first position;
wherein said second security tag part comprises:
a pin head from which said pin extends so as to be positioned for penetrating said garment article and for engaging said pin lock to lock said first security tag part and said second security tag part together when said garment article is sandwiched therebetween; and
a control unit operable for unlocking said first security tag part from said second security tag part when said garment article is sandwiched therebetween.

30. The system according to claim 29, wherein control unit comprises a radio transmitter configured for wireless communication with said security tag, and for transmitting a control signal to said security tag, and wherein said security tag comprises a radio receiver configured for receiving said control signal.

31. A security clip for locking a pin, said pin having a pin head and a pointy end opposite said pin head, said security clip comprising:
a bottom with a bottom surface and a bottom aperture configured for receiving said pointy end of said pin;
a clip axis defined through said bottom aperture;
a first spring arm extending from said bottom, and defining a first spring, and having an inclination with respect to said bottom surface, said first spring arm comprising a first end constituting a free end, and a second end opposite said free end, said first spring arm connected to said bottom at said second end at a distance from said bottom aperture; and
a first spring aperture configured for receiving said pointy end of said pin such that said pin extends through said bottom aperture and said first spring aperture when said pin is in said security clip, said first spring aperture defined in part by a contact edge configured for contacting said pin when said pin is in said security clip;
wherein a projection of said contact edge onto said bottom surface is between a first side of said clip axis and said second end in an equilibrium state of said first spring; and
wherein the projection of said contact edge onto said bottom surface is on a second side of said clip axis opposite the first side of said clip axis in a compressed state of said first spring, such that said contact edge is forced towards said clip axis so as to exert a locking force on said pin when said pin is in said security clip.

32. The security clip according to claim 31, wherein said first spring arm comprises a lower arm part, an upper arm part, and a fold defining an obtuse angle between said lower arm part and said upper arm part, said contact edge being between said free end and said fold.

33. The security clip according to claim 31, further comprising a second spring arm extending from said bottom and defining a second spring;
wherein said second spring arm extends opposite to said first spring arm with respect to said clip axis, and wherein said second spring arm comprises a second spring aperture configured for receiving said first spring arm.

34. An anti-theft security tag for a garment article, said security tag comprising:
a first tag part, and a second tag part, the first tag part and the second tag part being configured for sandwiching said garment article between said first tag part and said second tag part;
said first tag part comprising:
a pin lock configured for receiving and securing a pin, said pin being secured by said pin lock when said pin lock is in a locked state, said pin lock comprising a spring having a first deflected state when said pin lock is in the locked state; and
a security lock operable for moving said pin lock between the locked state and an unlocked state, wherein said security lock has an actuator movable between a first position and a second position, wherein said pin lock is in the locked state when said actuator is in said first position, and wherein said pin is releasable from said pin lock when said actuator is in said second position, and wherein said spring is deflected from said first deflected state to a second deflected state when said actuator is moved from said first position to said second position;
said second tag part comprising:
a pin head from which said pin extends so as to be positioned to penetrate said garment article, thereby engaging said pin lock for locking said first tag part and said second tag part together with said garment article sandwiched between said first tag part and said second tag part.
